(19) United States
(12) Patent Application Publication
(10) Pub. No.: US 2002/0042344 A1
(43) Pub. Date: Apr. 11, 2002

(54) Ceramic catalyst body and ceramic carrier

(76) Inventors: Tosiharu Kondo, Toyoake-city (JP); Masakazu Tanaka, Okazaki-city (JP); Tomohiko Nakanishi, Nishio-shi (JP); Kazuhiko Koike, Nishio-shi (JP)

Correspondence Address: LAW OFFICE OF DAVID G POSZ, 2000 L STREET, N.W., SUITE 200, WASHINGTON, DC, 20036, US

(21) Appl. No.: 09/961,151

(22) Filed: Sep. 24, 2001

(30) Foreign Application Priority Data
Sep. 29, 2000 (JP) 2000-297993
Oct. 2, 2000 (JP) 2000-301666
Jul. 26, 2001 (JP) 2001-225985

(51) Int. Cl. B01J 21/08

(52) U.S. Cl. 502/527.19; 502/251; 502/252

(57) ABSTRACT

The present invention improves a ceramic carrier capable of directly supporting a catalyst component and provides a ceramic carrier and a ceramic catalyst body which have high catalyst performance and practical value.

According to the present invention, in the ceramic catalyst body 1 having a catalyst component supported on the ceramic carrier 2 of monolith form having a multitude of pores or element capable of directly supporting the catalyst on the surface of cordierite, the quantity of catalyst per unit volume in the middle portion A of the carrier where much gas flows is set to 1.1 times, preferably twice or larger than that of the peripheral portion B. By having more catalyst in the middle portion of the carrier where much gas flows, the purification performance is improved.

### BACKGROUND OF THE INVENTION

1. Field of the Invention

The present invention relates to a ceramic carrier used as a carrier for supporting a catalyst component in a catalyst for purifying exhaust gas from an automobile engine or the like, and to a ceramic catalyst body.

2. Description of the Related Art

A catalyst has been used for the purification of exhaust gas, in which a monolith carrier made of cordierite having high resistance against thermal shock is coated with γ-alumina and is provided with a noble metal catalyst supported thereby. The coating layer is formed because the specific surface area of the cordierite is too small to support the required amount of catalyst component. Thus, the specific surface area of the carrier can be increased by means of a material having a large specific surface area such as γ-alumina.

When the surfaces of the carrier cell walls are coated with γ-alumina, however, the heat capacity of the carrier increases due to the increase in mass. Recently, studies have been made with a view to decreasing the heat capacity by making the cell wall thinner, in order to activate the catalyst earlier. However, the effect of this attempt is reduced by the formation of the coating layer. There have also been such problems in that the decrease in the cross sectional area of the cell increases the pressure loss, and the thermal expansion coefficient becomes larger than that of a carrier which is made simply of cordierite.

With the background described above, the present inventors have proposed a ceramic carrier which can support a required amount of catalyst component without forming the coating layer to increase the specific surface area (Japanese Patent Application No. 2000-104994). Although it has been studied to cause a particular component to elute through acid treatment or heat treatment thereby to increase the specific surface area of the cordierite itself (for example, Japanese Examined Patent Publication No. 5-503338), such approaches are not practical because acid treatment or heat treatment causes destruction of the crystal lattice of cordierite, resulting in lower mechanical strength.

### SUMMARY OF THE INVENTION

An object of the present invention is to improve the ceramic carrier described above, thereby to provide a ceramic carrier and a ceramic catalyst body having improved catalytic performance and high practical value.

According to a first aspect of the invention, the ceramic catalyst body comprises a ceramic carrier capable of supporting the catalyst directly on the surface of the ceramic substrate and a catalyst component supported by the ceramic carrier, wherein the amount of catalyst supported by a unit volume of the carrier at the middle portion thereof where the gas stream is maximum is set to 1.1 times that of the periphery or larger. The gas purification ratio can be improved by having more catalyst supported at the middle portion of the carrier where the gas stream is maximum.

According to a second aspect of the invention, the ceramic catalyst comprises a ceramic carrier capable of supporting the catalyst directly on the surface of the ceramic substrate, where the surface area per unit volume of carrier at the middle portion thereof where the gas stream velocity is highest is set to 1.1 times that of the periphery or larger. Similar effects to those of the first aspect can be achieved also by controlling the specific surface area of the ceramic carrier, and the purification ratio can be improved by having the catalyst supported by the ceramic carrier the surface area of which is increased at the middle portion thereof.

According to a third aspect of the invention, the surface area of the carrier, which has the constitution of the second aspect, at the middle portion thereof may be increased by, for example, making the carrier in a monolith with the middle portion of the carrier being made to have a high cell density or in polygonal or circular cell form. The peripheral portion of the carrier may, in contrast, be made to have a low cell density or in rectangular, hexagonal or triangular cell form.

According to a fourth aspect of the invention, with the projection area of a gas inlet onto the ceramic carrier denoted as S, the middle portion of the carrier is identified as a region which has a cross sectional area in a range from 1.1 to 2 times the projection area S, with the center of projection of the gas inlet at the center. Since the zone of large flow rate or high velocity of gas stream changes within the range described above depending on the engine running condition, the middle portion and the peripheral portion of the carrier may be set with reference to this range according to the required performance.

According to a fifth aspect of the invention, the ceramic catalyst comprises a ceramic carrier capable of supporting the catalyst directly on the surface of ceramic substrate, wherein 50% by weight or more of the entire catalyst is concentrated in a region from the upstream end of the carrier to a point one quarter to one third of the entire length. Catalyst reaction can be enhanced by increasing the catalyst density in the region from the upstream end to a point one quarter to one third of the entire length where the initial catalyst reaction takes place.

According to a sixth aspect of the invention, the ceramic catalyst comprises a ceramic carrier capable of supporting the catalyst directly on the surface of the ceramic substrate and a catalyst component supported by the ceramic carrier, wherein a catalyst having high heat resistance is disposed in the upstream of the incoming gas and a catalyst having low heat resistance is disposed in the downstream. In the case where a plurality of kinds of catalyst are used, deterioration of the catalyst can be prevented by disposing the catalyst having higher heat resistance in the upstream of the incoming gas where the temperature tends to be higher.

According to a seventh aspect of the invention, the catalyst having higher heat resistance described above is a catalyst of an inlet temperature not higher than 300° C. with a purification ratio of 50%, and the catalyst having lower heat resistance described above is a catalyst of an inlet temperature not lower than 350° C. with a purification ratio of 50%. The effect of the sixth aspect can be easily achieved by combining such plurality of catalysts.

According to an eighth aspect of the invention, cross sectional area of the catalyst in each of the aspects described above is preferably larger than the cross sectional area of a gas inlet tube connected to the ceramic catalyst. While the process capacity can be increased by increasing the catalyst volume when the cross sectional area is large, this increases the possibility of the problem described above occurring, due to the gas stream flowing through the middle portion and the periphery of the catalyst. Thus, the effects of the constitutions of the aspects described above can be favorably achieved.

According to a ninth aspect of the invention, the ceramic catalyst body comprises a ceramic carrier capable of supporting the catalyst directly on the surface of the ceramic substrate and a catalyst component supported by the ceramic carrier, wherein the catalyst comprises particles of such a shape that has a larger surface area than spherical or semi-spherical particles of the same weight.

Exhaust gas purification performance depends on the surface area of the catalyst, and the larger the surface area, the higher the probability of making contact with the exhaust gas, resulting in higher performance. The surface area of a given quantity of catalyst may be increased, for example, by reducing the catalyst particle size, but this approach has its limitation. Accordingly, the present invention takes notice of the shape of the catalyst particle and employs a shape that has a larger surface area than spherical or semi-spherical particles of the same weight. Provided that each of the catalyst particle has the same weight, the surface area is minimum when the catalyst particle has a spherical shape. Thus, the effective area contributing to the catalyst reaction can be increased for higher catalytic performance by making the catalyst particles in a shape other than spherical (or semi-spherical) shape.

According to a tenth aspect of the invention, the shape of the catalyst particles may be at least one of polyhedron, conical shape or cone missing a part thereof, substantially spherical shape having surface irregularities or projections, needle and hollow particles. All of these shapes has a surface area larger than that of spherical (or semi-spherical) shape.

According to an eleventh aspect of the invention, the ceramic catalyst body comprises a ceramic carrier capable of supporting the catalyst directly on the surface of the ceramic substrate and a catalyst component supported by the ceramic carrier, wherein the catalyst is oriented in a plane which has high catalytic activity.

With a given shape of the catalyst particle, purification performance becomes higher when the catalyst is oriented in a plane which has high catalytic activity. Thus, the catalytic performance can be improved also by orienting the catalyst in a plane which has high catalytic activity, instead of increasing the surface area.

According to a twelfth aspect of the invention, the catalyst is supported in the pores by impregnating the ceramic carrier with a catalyst solution and sintering. Use of the solution makes it easier for the catalyst component to infiltrate into the pores, and also to form smaller particles, since the catalyst component is supported in the form of ions.

According to a thirteenth aspect of the invention, one or more constituent elements of the ceramic substrate is substituted with an element other than the constituent element, and a carrier which is capable of supporting the catalyst component directly on the substituting element can be used.

In this case, according to a fourteenth aspect of the invention, the catalyst component is preferably supported on the substituting element through chemical bonding. Chemical bonding of the catalyst component improves the retention of the catalyst and mitigates deterioration over a long period of use, since the catalyst component is evenly distributed over the carrier without coagulating.

According to a fifteenth aspect of the invention, one or more elements having d or f orbits in the electron orbits thereof can be used as the substituting element described above. Elements which have d or f orbit in the electron orbits thereof have higher tendency to bond with the catalyst component, and are therefore preferable.

According to a sixteenth aspect of the invention, the ceramic catalyst has a multitude of pores capable of directly supporting the catalyst on the surface of the substrate ceramic so that the catalyst component can be supported directly in the pores.

According to a seventeenth aspect of the invention, the pores described above comprise at least one kind selected from among a group of defects in the ceramic crystal lattice, microscopic cracks in the ceramic surface and missing defect of the element which constitute the ceramic.

According to an eighteenth aspect of the invention, the microscopic cracks are preferably 100 nm or smaller in width in order to ensure the mechanical strength of the carrier.

According to an nineteenth aspect of the invention, the pores have diameter or width preferably 1000 times the diameter of the catalyst ion to be supported or smaller, in order to be capable of supporting the catalyst component. At this time, a quantity of catalyst component similar to that in the prior art can be supported when the density of the pores is 1×10¹¹/L or higher.

According to an twentieth aspect of the invention, a ceramic which contains cordierite as the major component is used as the matrix ceramic, and the pores may be defects formed by substituting a part of the constituent elements of the cordierite with metal element having different value of valence. Cordierite has high resistance against thermal shock and is therefore suitable for the catalyst to purify the automobile exhaust gas.

According to a twenty first aspect of the invention, the pores are at least one kind, oxygen defect or lattice defect. A quantity of catalyst component similar to that in the prior art can be supported when the density of cordierite crystal which includes at least one defect in a unit crystal lattice of cordierite is set to 4×10⁻⁶% or higher.

### BRIEF DESCRIPTION OF THE DRAWINGS

FIG. 1 is a perspective view showing the overall constitution of a ceramic catalyst body according to first embodiment of the invention.

FIG. 2 shows the relationship between the gas flow and purification ratio.

FIG. 3 is a diagram showing the manufacturing process for the ceramic catalyst body according to the first embodiment of the invention.

FIG. 4 shows the relationship between the ratio of catalyst quantity and the purification rate.

FIGS. 5(a), 5(b) and 5(c) show examples of connection of gas inlet to ceramic carrier, FIG. 5(a) showing a case where the gas inlet and the ceramic carrier are disposed in a concentric arrangement, FIG. 5(b) showing a case where the gas inlet and the axis of the ceramic carrier are offset from each other, and FIG. 5(c) showing a case where the gas inlet is connected obliquely.

FIGS. 6(a) to 6(e) show examples of cross sectional shape of the ceramic carrier, FIG. 6(a) showing circular cross section, FIG. 6(b) showing oval cross section, FIG. 6(c) showing race track-shaped cross section, FIG. 6(d) showing triangular cross section and FIG. 6(e) showing irregular cross section.

FIGS. 7(a), 7(b) and 7(c) show examples of the shape of ceramic carrier cell, FIG. 7(a) showing rectangular cell, FIG. 7(b) showing hexagonal cell, and FIG. 7(a) showing triangular cell.

FIGS. 8(a) to 8(h) are perspective views showing the overall constitution of a ceramic catalyst body according to second embodiment of the invention, FIGS. 8(a) to 8(g) showing cell patterns and FIG. 8(h) showing a method for forming a die.

FIG. 9 shows the overall constitution of a ceramic catalyst body according to third embodiment of the invention, temperature distribution in the ceramic catalyst body and catalyst distribution.

FIG. 10(a) is a diagram showing the manufacturing process for the ceramic catalyst body according to the third embodiment of the invention, and 10(b) shows another constitution of the ceramic catalyst body.

FIG. 11(a) shows an example of the constitution of ceramic catalyst body according to the third embodiment of the invention, and 11(b) shows the relationship between the quantity of catalyst supported in the upstream and the purification rate.

FIG. 12(a) is a diagram showing the overall constitution of the ceramic catalyst body according to fourth embodiment of the invention, and 12(b) shows another constitution of the ceramic catalyst body.

FIG. 13 shows the relationship between the catalyst inlet temperature and the purification rate for a catalyst having high heat resistance and a catalyst having low heat resistance.

FIG. 14 schematically shows the constitution of ceramic catalyst body of the prior art having spherical catalyst particles supported on a ceramic carrier.

FIGS. 15(a) and 15(b) are diagrams of the constitution of ceramic catalyst body of the invention having catalyst particles of polyhedron shape supported on a ceramic carrier, FIG. 15(a) showing hexahedron particle and FIG. 15(b) showing particles having tetrahedrons.

FIG. 16 shows the constitution of ceramic catalyst body of the invention having catalyst particles of truncated conical shape supported on a ceramic carrier.

FIGS. 17(a) and 17(b) are diagrams of the constitution of ceramic catalyst body of the invention having catalyst particles which have surface irregularity or projections supported on a ceramic carrier, FIG. 17(a) showing particles which have surface irregularity and FIG. 17(b) showing particles which have projections.

FIG. 18 shows the constitution of ceramic catalyst body of the invention having catalyst particles of needle shape supported on a ceramic carrier.

FIG. 19 shows the constitution of ceramic catalyst body of the invention having catalyst particles of flake shape supported on a ceramic carrier.

FIGS. 20(a) and 20(b) are diagrams of the constitution of ceramic catalyst body of the invention having hollow catalyst particles supported on a ceramic carrier, FIG. 20(a) showing particles tube shape and FIG. 20(b) showing particles which have bottomed holes.

FIG. 21 shows the constitution of ceramic catalyst body of the invention having catalyst particles which are oriented in a plane of high catalytic activity supported on a ceramic carrier.

FIG. 22 shows the relationship between the particle shape and the 50% purification temperature.

### DESCRIPTION OF THE PREFERRED EMBODIMENTS

The first embodiment of the invention will now be described below with reference to FIG. 1. A ceramic catalyst body 1 of the invention is used in an engine exhaust gas purification catalyst or the like, and has a ceramic carrier 2 which can directly support the catalyst. The ceramic carrier 2 is formed in a cylindrical monolith having a multitude of cells 21 formed in parallel to each other in the direction of gas stream, and has the catalyst component directly supported on the surface thereof. The ceramic carrier 2 is typically made of a ceramic material constituted mainly from cordierite having theoretical composition of 2MgO.2Al₂O₃.5SiO₂. The main component of the ceramic may also be alumina, spinel, aluminum titanate, silicon carbide, mullite, silica-alumina, zeolite, zirconia, silicon nitride, zirconium phosphate or the like, as a matter of course.

The ceramic carrier has a multitude of pores or elements capable of directly supporting the catalyst component provided on the surface of the ceramic substrate, so that the catalyst component can be supported directly by the pores or the elements. The pores which are capable of directly supporting the catalyst component comprise at least one kind selected from among a group consisting of defects in the ceramic crystal lattice (oxygen defect or lattice defect), microscopic cracks in the ceramic surface and defects in the elements which constitute the ceramic, or a combination thereof. The element capable of directly supporting the catalyst component is element introduced by substituting one or more of the elements which constitute the substrate ceramic with an element other than the constituent element. By providing the pores or the elements described above, it is possible to support the catalyst component without forming a coating layer which has large specific surface area such as γ-alumina.

This embodiment is characterized in that the quantity of the catalyst supported by the ceramic carrier 2 is made larger in the middle portion A of the carrier where much gas flows and smaller in the peripheral portion B of the carrier where less gas flows. Specifically, weight of the catalyst per unit volume in the middle portion A of the carrier is set to 1.1 times, preferably twice or larger than that of the peripheral portion B. This improves the purification performance. This constitution will be described in more detail later.

For the catalyst component, rare metals such as Pt, Pd and Rh are preferably used. The catalyst component may be supported by immersing the ceramic carrier in a solution of a compound of catalyst metal dissolved in a solvent. While the solvent for the catalyst component may be water, a solvent having smaller surface tension, for example an alcohol solvent such as ethanol, is preferable in the case where the ceramic carrier 2 of the invention has pores, since the defects or cracks which constitutes the pores have microscopic size. While a solvent which has large surface tension such as water is difficult to infiltrate into the pores and is unable to fully make use of the pores, use of the solvent having smaller surface tension which can infiltrate into microscopic pores makes it possible to support 0.5 g/L or more catalyst component by making full use of the pores.

The ceramic carrier immersed in the catalyst solution is then dried and sintered at a temperature from 500 to 900° C. This make a ceramic catalyst body having the catalyst component supported in the pores formed in the cell wall surface of the carrier which makes contact with the exhaust gas. In the case of the ceramic catalysts of the prior art which utilize γ-alumina coating layer or the like, catalyst component ma be present at portions that cannot be reached by exhaust gas. In the case of the ceramic catalysts of the invention, in contrast, the catalyst component is concentrated on the cell wall surface which has high probability of making contact with the exhaust gas, thus making it possible to make full use of the pores. Also, because the catalyst is supported by using the solution, the catalyst can be make in fine particles. Moreover, since gas can easily enter the pores can be infiltrated by the solution, the catalyst component can be supported efficiently only in portions which make contact with the exhaust gas.

Now the ceramic carrier 2 having multitude of pores capable of directly supporting the catalyst component in the surface of the substrate ceramic will be describes below. Since diameter of the ions of the catalyst component to be supported is typically about 0.1 nm, ions of the catalyst component can be supported in the pores formed in the surface of the cordierite, provided that the pores are 0.1 nm or larger in diameter or width. In order to ensure the mechanical strength of the ceramic, the diameter or width of the pores is preferably as small as possible, within 1000 times (100 nm) the diameter of the ions of the catalyst component. The depth of the pores is set to a half (0.05 nm) of the diameter or larger, for the purpose of retaining the ions. In order to support the catalyst component of a quality comparable to that of the prior art (1.5 g/L)with the pores is 1×10¹¹/L or higher, preferably 1×10¹⁶/L or higher and more preferably 1×10¹⁷/L or higher.

The preferred density of pores in the ceramic carrier described above can be achieved with a cordierite honeycomb structure which includes a 4×10⁻⁶% or more and preferably 4×10⁻⁵% or more cordierite crystal having at least one kind of oxygen defect or lattice defect in the unit crystal lattice, or which includes at least one kind of oxygen defect or lattice defect in the unit crystal lattice of cordierite in a density of 4×10⁻⁶ or higher, and preferably 4×10⁻⁷ or higher. Details of the pre and the method for forming the same will be described below.

Among the pores formed in the ceramic surface, defects in the crystal lattice are classified into oxygen defect and lattice defect (metal vacancy and lattice strain). Oxygen defect is caused by the lack if oxygen atoms which constitutes the crystal lattice of the ceramic, and allows it to support the catalyst component in the vacancy left by the missing oxygen. Lattice defect is caused by trapping of more oxygen atoms than necessary to form the ceramic crystal lattice, and allows it to support the catalyst component in the pores formed by the strains in the crystal lattice and metal vacancies.

Oxygen defects may be formed in the crystal lattice as described in Japanese Patent Application No. 2000-104994, in a process of forming, degreasing and firing a material for cordierite which contains a Si source, Al source and Mg source by either \mathring{1} decreasing the pressure of the firing atmosphere or making it a reducing atmosphere; \mathring{2} firing a low-oxygen concentration atmosphere using compound which does not contain oxygen for at least a part of the raw material so as create oxygen deficiency in the firing atmosphere or in the starting material; or \mathring{3} substituting at least one of the constituent elements of the ceramic except for oxygen with an element having a value of valence lower than that of substituted element. In the case of cordierite, since the constituent element has positive valence such as Si (4+), Al (3+) and Mg (2+), substituting these element with an element of lower value of valence leads to deficiency of positive charge which corresponds to the difference from the substituting element in the value of valence and to the amount of substitution. Thus, O (2−) having negative charge is released so as to maintain the electrical neutrality of the crystal lattice, thereby forming the oxygen deficiency.

Lattice defects can be formed by \mathring{4} substituting a part of the constituent elements of the ceramic except for oxygen with an element having a value of valence higher than that of the substituted element. When at least part of Si, Al and Mg which are constituent elements of the cordierite is substituted with an element having a value of valence higher that of the substituted element, a positive charge which corresponds to the difference from the substituting element in the value of valence and to the amount of substitution becomes redundant, so the O (2−) having a negative charge of necessary amount is taken in to maintain the electrical neutrality of the crystal lattice. The oxygen atoms which have been taken in constitutes obstacles for the cordierite unit crystal lattice in forming an orderly structure, thus resulting in lattice strain. Alternatively, part of Si, Al and Mg is released to maintain the electrical neutrality of the crystal lattice, thereby forming vacancy. In the case, firing is carried out in an air atmosphere so as toe supply sufficient amount of oxygen. Since the sizes of these defects are believed to be in the order of several angstroms or smaller, they are not accounted for in the specific surface area measure by ordinary methods such as the BET method which used nitrogen molecules.

The number of oxygen defects and lattice defects is related to the amount of oxygen included in the cordierite honeycomb structure, and it is possible to support the required quantity of catalyst by controlling the amount of oxygen to below 47% by weight (oxygen defect) or over 48% by weight (lattice defect). When the amount of oxygen is decreased to below 47% by weight due to the formation of oxygen defect, the number of oxygen atoms included in the cordierite unit crystal lattice becomes less that 17.2, and the lattice constant for bₒ axis of the cordierite crystal becomes smaller than 16.99. When the amount of oxygen is increased beyond 48% by weight due to the formation of lattice defect, the crystal lattice becomes more that 17.6, and the lattice constant for the bₒ axis of the cordierite crystal becomes larger or smaller that 16.99.

Among the pores which can support catalyst, microscopic cracks in the ceramic surface are formed in multitude at least one of amorphous phase and crystal phase by applying thermal shock or shock waves to the cordierite honeycomb structure. The cracks are requires to be small, about 100 nm or less, preferably 10 nm or smaller in width in order to ensure the mechanical strength of the carrier.

Thermal shock can be applied by quenching the cordierite honeycomb structure which has been heated. Timing of applying the thermal shock may be after the cordierite crystal phase or amorphous phase has been formed in the cordierite honeycomb structure. Thermal shock may be applied either by forming, degreasing and firing a material for cordierite which contains a Si source, Al source and Mg source in an ordinary process, heating the cordierite honeycomb structure thus formed to a predetermined temperature again and then quenching it or by quenching from a predetermined temperature during the transition from firing to cooling. Cracks due to thermal shock can be generated with a temperature difference (thermal shock temperature difference) of about 80° C. or larger between the time of heating and after quenching, while the crack size increases as the thermal shock temperature difference increases. The thermal shock temperature difference should be kept within about 900° C., since too large cracks makes it difficult to maintain the shape of the honeycomb structure.

In the cordierite honeycomb structure, the amorphous phase is present in layers around the crystal phase. When thermal shock is applied by heating and then quenching the cordierite honeycomb structure, since there is a difference in the thermal expansion coefficient between the amorphous phase and the crystal phase, a thermal stress corresponding to the difference in the thermal expansion coefficient and the thermal shock temperature difference is generated around the interface between the amorphous phase and the crystal phase. When the amorphous phase or the crystal phase is unable to endure the thermal stress, microscopic cracks are generated. The number of cracks generated can be controlled by the amount of amorphous phase. When a trace component (alkali metal, alkali earth metal, etc.) of the raw material which is believed to contribute to the formation of the amorphous phase is added in a quantity larger that normal, the number of cracks generated is increased. Shock waves of ultrasound or vibration can also be used instead of thermal shock. When a weak portion of the cordierite honeycomb structure in unable to endure the thermal shock, microscopic cracks are generated. The number of cracks generated can be controlled by the energy of the shock waves.

Among the pores which can support the catalyst, defects of elements which constitute the ceramic are formed through elution of the constituent element of the cordierite or impurity by a liquid phase method. For example, the defects are formed when metal elements such as Mg and Al included in the cordierite crystal, alkali metal, alkali earth metal included in the amorphous phase or the amorphous phase itself dissolves into water of high temperature and high pressure, super-critical fluid or a solution such as alkali solution. These defects of elements form pores which support the catalyst. The defects may also be formed chemically or physically by a gas phase method. The chemical method includes dry etching and physical method includes sputtering etching, where the number of pores can be controlled through the duration of etching or the amount of energy supplied.

Now a carrier having a multitude of elements capable of directly supporting the catalyst component deposited on the surface of the substrate ceramic by the substitution of elements will be described below. In this case, constituent elements of the ceramic (for example, Si, Al and Mg in the case of cordierite) are substituted by an element which has greater force for bonding with the supported catalyst that the substituted element and is capable of supporting the catalyst component by chemical bonding. Specifically, the substituting element may be among those which are different from the constituent elements and have a d or f orbit in the electron orbits, and preferably have an empty orbit in the d or f orbit or have two or more oxidation states. An element having an empty orbit in the d or f orbit has an energy level near that of the supported catalyst, which means a higher tendency to exchange electrons and bond with the catalyst component. An element which has two or more oxidation states also has a higher tendency to exchange electrons and provides the same effect.

Elements which have empty orbit in the d or f orbit include W, Ti, V, Cr, Mn, Fe, Co, Ni, Zr, Mo, Ru, Rh, Ce, Ir and Pt, of which one or more can be used. Among these, W, Ti, V, Cr, Mn, Fe, Co, Mo, Ru, Rh, Ce, Ir, and Pt are elements which have two or more oxidation states. Besides these, elements which have two or more oxidation states include Cu, Ga, Ge, Se, Pd, Ag, Au, etc.

When substituting the constituent element of ceramic with these substituting elements, a method may be employed in which the substituting element is added to the ceramic material and the mixture mixed. However, a methods may also be employed in which the material containing the constituent element to be substituted is reduced by the amount corresponding to the amount of substituting, followed by mixing, forming and drying, before being immersed in a solution which contains the substituting element. The material is taken out of the solution, dried and then subjected to degreasing and firing in an air atmosphere. This method of impregnating the preform is preferably employed, since the substituting element can be deposited sufficiently on the surface of the preform and, as a result, the element is substituted on the surface during firing, thus making it easier for a solid solution to form.

The amount of substituting element is set within a range from 0.01% to 50%, and preferably in a range from 5 to 20% of the substituted constituent element in terms of the number of atoms. In the case where the substituting element has a value of valence different from that of the constituent element of substrate ceramic, lattice defect or oxygen defect takes place at the same time, depending on the difference in valence, as described above. However, defect can be prevented from occurring by using a plurality of substituting elements and setting the sum of oxidation numbers of the substituting elements equal to the sun of oxidation numbers of the substituted constituent elements. Thus, the catalyst component may be supported only by bonding with the substituting elements while keeping the valence constant as a whole.

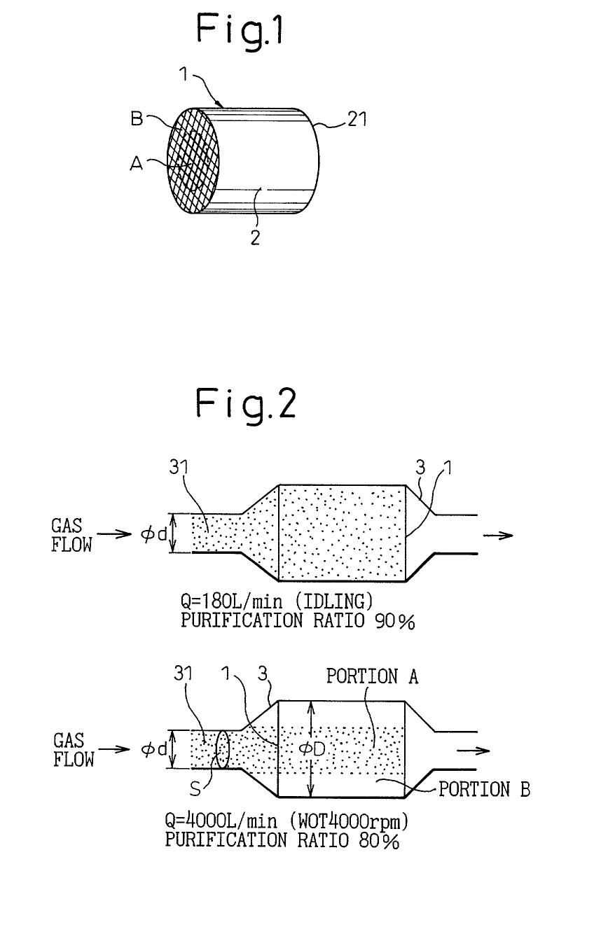

Now features of the embodiment will be described below. According to this embodiment, the amount of catalyst supported by unit volume of the ceramic carrier 2 in the middle portion A thereof where much gas flows is set to 1.1 times, preferably twice or larger that of the peripheral portion B. FIG. 2 shows the relationship between gas flow and purification rate in the case of ceramic catalyst 1 which has the catalyst supported uniformly over the entire ceramic carrier (for an engine having displacement of 2000 ml). It is shown that, during idling when the gas flow decreases (top of FIG. 2), the gas introduced through a gas inlet 31 having diameter d of an exhaust tube 3 which accommodates the ceramic catalyst 1 spreads all over the exhaust tube 3. At this time, the gas flows through the entire surface area (area of diameter D, D>d) of the ceramic catalyst 1, achieving a purification ration of 90% (10% remaining not purified). During full throttle operation when the gas flow increases (bottom of FIG. 2), the gas introduced through the gas inlet 31 of the housing 3 which accommodates the ceramic catalyst 1 is concentrated and flows through the middle portion A of the carrier, with the purification ration decreasing to 80% (20% remaining not purified). The middle portion A of the carrier is a little eider that the region of diameter d, and can be represented as 1.1 times the area S of the gas inlet 31 projected onto the ceramic carrier. The projections area S equals the cross sectional area of the gas inlet 31 in this case.

The portion of gas remaining not purified is 20% when the gas is concentrated and flows through the middle portion A of the carrier (region 1.1 times the projection area S), and is 10% when the gas is purified in the entire area including the peripheral portion B. Therefore, the quantity of the catalyst is increased in the middle portion A of the carrier where much gas flows, and is decreased in the peripheral portion B where less gas flows. The middle portion A of the carrier is set in a range from 1.1 times to 2 times the projection area S around the center of projection of the gas inlet 31 onto the ceramic carrier. The middle portion A of the carrier has the above range because the region in which the gas flow is concentrated spreads to a zone twice as large as the projection area S, with 90% or more of the gas being purified in this zone when the engine is running at low to medium speeds other than idling or full throttle operation.

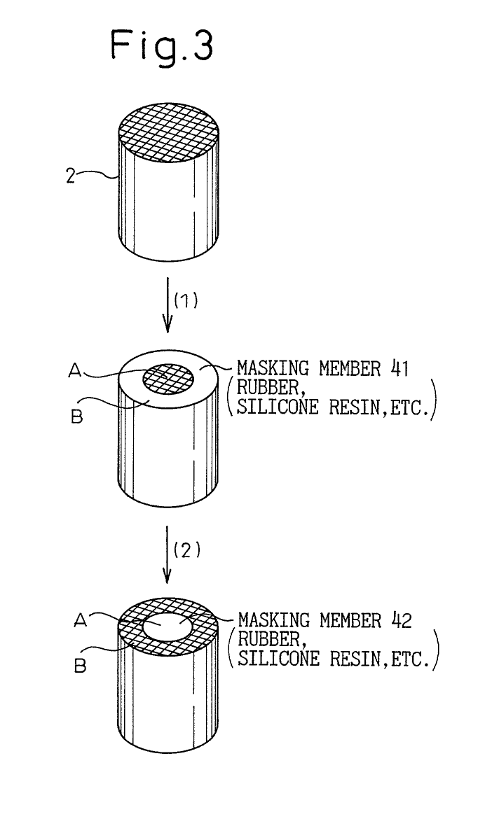

The quantity of the catalyst in the middle portion A of the carrier can be made larger that in the peripheral portion B by carrying in two steps. An example of the process of supporting the catalyst will be described below for a ceramic carrier 2 (φ86×L120) shown in FIG. 3. First, in process (1), top and bottom end faces of the peripheral portion B of the carrier are covered by making members 41, and a solution which contains the catalyst component is caused to flow through the middle portion A of the carrier (portion of diameter d), so as to deposit form 50% to 80% of the total quantity of catalyst therein. Specifically, microcrystalline acid wax is used as the making member 41, and ethanol containing 0.09 mol/L of Pt and 0.06 mol/L of Rh is used as the catalyst solution. The carrier is immersed in this solution of 10 minutes at room temperature. Then the carrier taken out of the solution is subjected to air blowing to remove the excess solution from the cells, and is dried at 90° C. for two hours, thereby causing the catalyst to be supported in the middle portion A of the carrier.

Then in process (2), the masking members 41 are removed from the peripheral portion B, and the middle portion A of the carrier is covered by masking member 42. The catalyst solution is caused to flow through the peripheral portion B of the carrier to have the rest of the catalyst supported therein. Specifically, microcrystalline acid wax is used as the masking member 42, and ethanol containing 0.045 mol/L of Pt and 0.03 mol/L of Rh is used as the catalyst solution. The carrier is immersed in this solution for 10 minutes at room temperature. Then the carrier taken out of the solution is subjected to air blowing to remove the excess solution form the cells, and is dried at 90° C. for two hours, thereby causing the catalyst to be supported in the peripheral portion B of the carrier. In each process, the catalyst is supported by immersing the carrier in the catalyst solution for 10 minutes at room temperature, applying air blowing to the carrier which is taken out of the solution to remove the excess solution form the cells, and drying at 90 ° C. for two hours

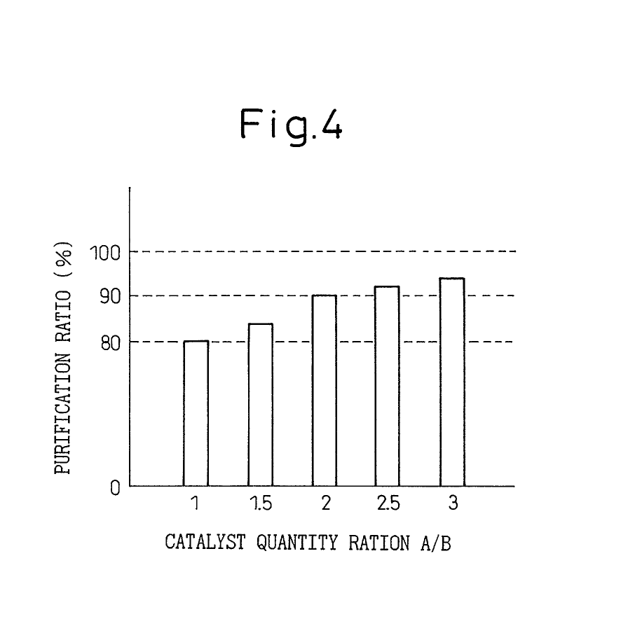

Then the catalyst is sintered at a temperature from 500 to 800° C. to make the ceramic catalyst body 1. The ceramic catalyst 1 has the catalyst with a density of 3.0 g/L in the middle portion A, which is twice higher than 1.5 g/L in the peripheral portion B. By changing the concentration of the catalyst solution which infiltrates the middle portion A, various pieces of the ceramic catalyst body 1 were made by a similar method with the density of catalyst in the middle portion A being 1.5 g/L, 2.25 g/L, 3.75 g/L and 4.5 g/L, and the density in the peripheral portion B being fixed at 1.5 g/L, and the purification performance of each specimen was examined. FIG. 4 shows the purification ratio as a function of the ratio of the catalyst quantities A/B between the middle portion A and the peripheral portion B. The region of diameter d (φ50) was taken as the middle portion A, and the purification ratio was measured under conditions of engine displacement 2000 ml and gas flow rate of 4000 L/min.

As can be seen from FIG. 4, the purification ratio is 80% when the ratio of the catalyst quantities A/B is 1:1, while the purification ratio increases as the quantity of catalyst in the middle portion A increases. Thus, since the effect of increasing the quantity of catalyst can be achieved when the value of A/B is 1.1 or larger, the ratio of the catalyst quantities A/B may be determined in accordance with the target performance and cost. When A/B=2, a purification ratio of 90% is achieved. Thus, the portion of gas remaining not purified can be restricted to 10% or less by setting the ratio A/B to 2 or higher.

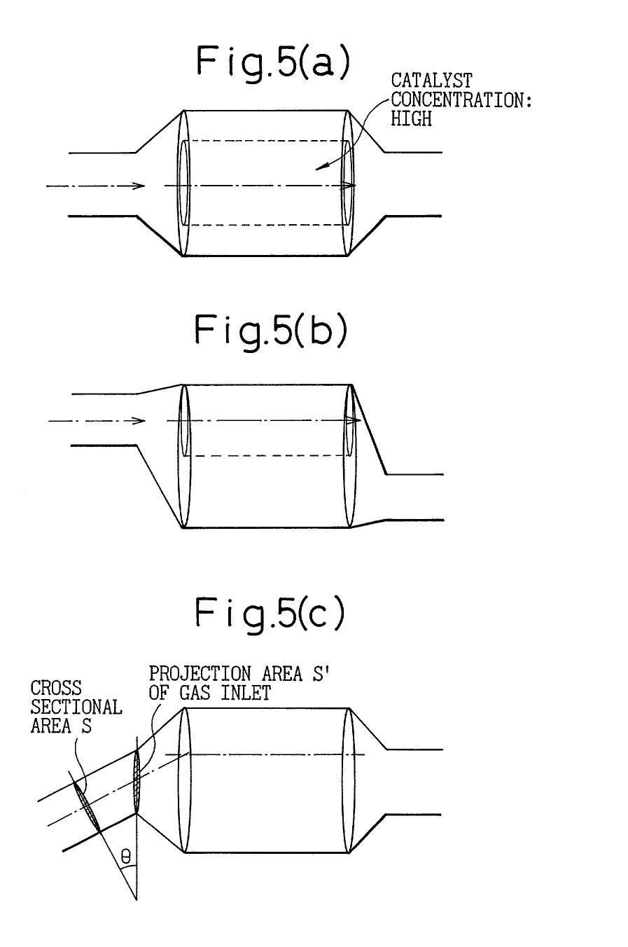

As shown in FIGS. 5(a) to 5(c), center of the middle portion A of the carrier is set so as to substantially coincide with the center of the gas inlet 31 (center of projection), even when the position of connecting the exhaust tube 3 to the ceramic catalyst body 1 varies. That is, in the case where the gas inlet 31 of the exhaust tube 3 and the ceramic catalyst body 1 are disposed concentrically as in the embodiment described above, the center of the middle portion A of the carrier coincides with the center of the gas inlet 31 and also with the center of the ceramic catalyst body 1 as shown in FIG. 5(a). In the case where the axis of the exhaust tube 3 and the axis of the ceramic catalyst body 1 are offset from each other as shown in FIG. 5(b), too, center of the middle portion A of the carrier is set so as to coincide with the center of the gas inlet 31. In this case, however, the center of the middle portion A of the carrier and the center of the ceramic catalyst body 1 are not disposed concentrically.

In the case where the gas inlet 31 of the exhaust tube 3 is connected to the ceramic carrier 2 in a direction oblique to the ceramic catalyst body 1 as shown in FIG. 5(c), an arrangement is employed in which the center of the middle portion A of the carrier is located on an extension of the center of the gas inlet 31 (center of projection). The area S of the gas inlet 31 projecting onto the ceramic carrier 2 is calculated as follows from the cross sectional area S of the gas inlet 31.

Projection area S=Cross sectional area S×(1/cos θ)

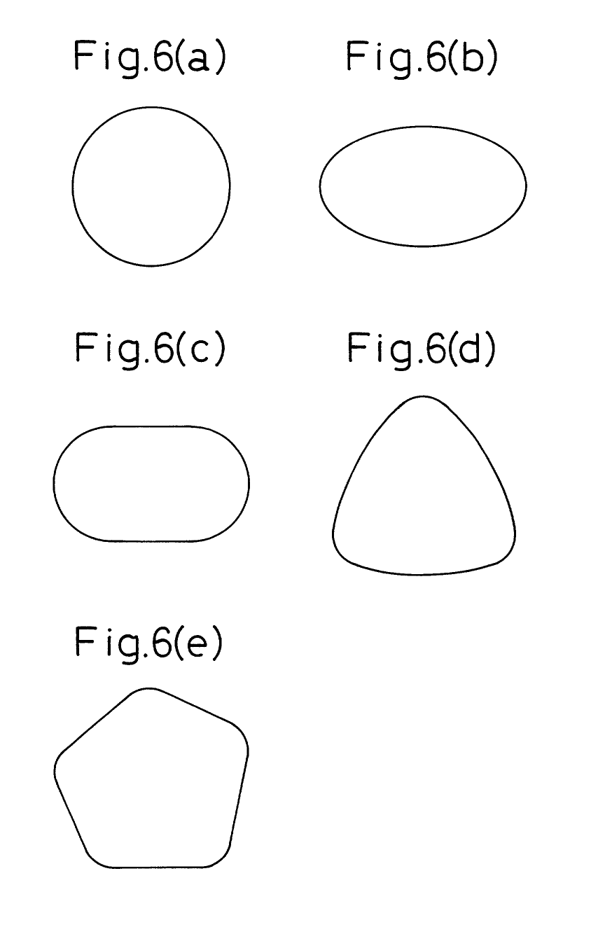

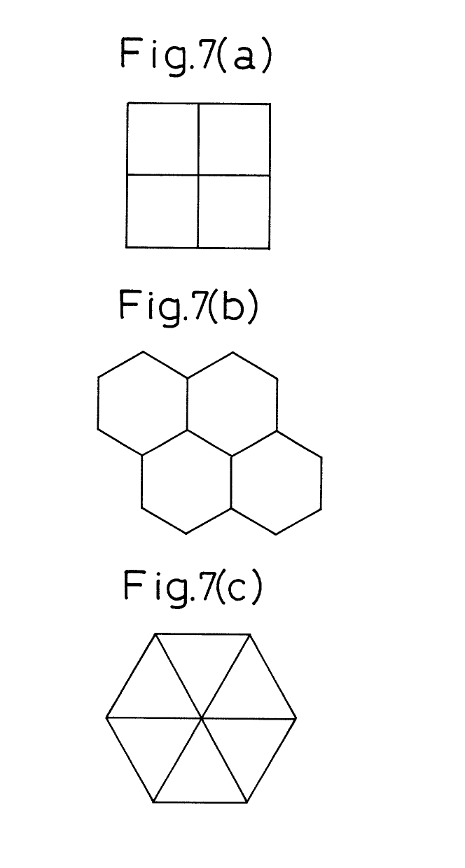

As shown in FIGS. 6(a) to 6(e), the cross sectional shape of the ceramic carrier 2 may be, besides the circular cross section shown in FIG. 6(a), oval cross section shown in FIG. 6(b), race track-shaped cross section shown in FIG. 6(c), triangular cross section shown in FIG. 6(d) or modified cross section shown in FIG. 6(e). The cell 21 may also have any shape other than the rectangle shown in FIG. 7(a), such as the hexagonal shape shown in FIG. 6(b) or the triangle shown in FIG. 6(c). In the case of such a different shape, too, the center position and region of the middle portion A of the carrier can be determined similarly to that described above.

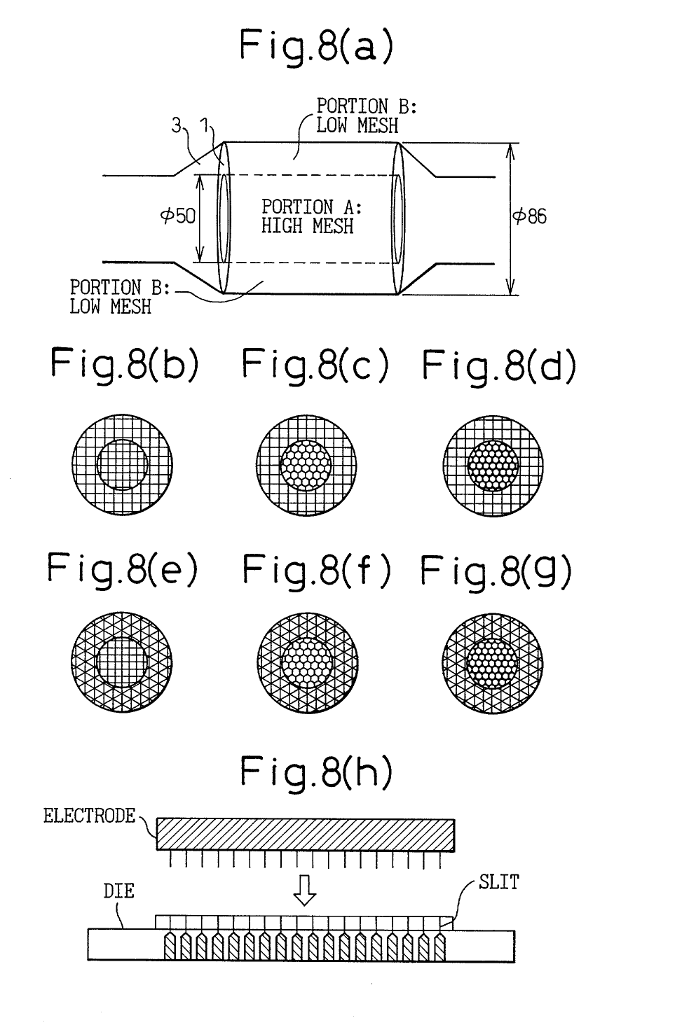

The second embodiment of the invention is shown in FIG. 8(a). In this embodiment, surface area per unit area is made larger in the middle portion A of the carrier where the gas velocity is high than in the peripheral portion B, instead of making the quantity of catalyst larger in the middle portion A of the carrier than in the peripheral portion B. Specifically, the surface area per unit area in the middle portion A of the carrier is set to 1.1 times and preferably twice as large as that in the peripheral portion B. For example, the density of cells (number of cells per unit area) is set higher in the middle portion A of the carrier (high mesh) and lower in the peripheral portion B (low mesh) as shown in FIG. 8(b). Alternatively, an arrangement as shown in FIGS. 8(c) to (g) may also be employed, in which the cells in the middle portion A of the carrier are formed in polygonal or circular shape, which has a larger surface area, and the cells in the peripheral portion B are formed in triangular or rectangular shape, which has smaller surface area.

FIG. 8(a) shows an example of the constitution, wherein the middle portion A of the carrier is formed as follows:

Cell: Rectangular, with wall thickness of 0.065 mm

Mesh: 1500 cells/in² with diameter of 50

Volume: 236 ml, with catalyst density 1.5 g/L

The peripheral portion B of the carrier is formed as follows:

Cell: Rectangular, with wall thickness of 0.115 mm

Mesh: 400 cells/in²

Volume: 461 ml, with catalyst density 1.5 g/L

Thus, the density of cells and the surface area are set larger in the middle portion A of the carrier.

A similar effect can be achieved also by making the surface area per unit area in the middle portion A of the carrier where the gas velocity is higher than that in the peripheral portion B as described above. While the same quantity of catalyst is supported in the middle portion A of the carrier and the peripheral portion B in the example described above, the quantity of the catalyst may also be made larger in the middle portion A as in the case of the first embodiment. To form the cells in the shapes as shown in FIGS. 8(c) to 8(g), a slit is formed in a die by electric spark machining using an electrode which is machined in a desired cell pattern as shown in FIG. 8(h) thereby to form the cells using the die.

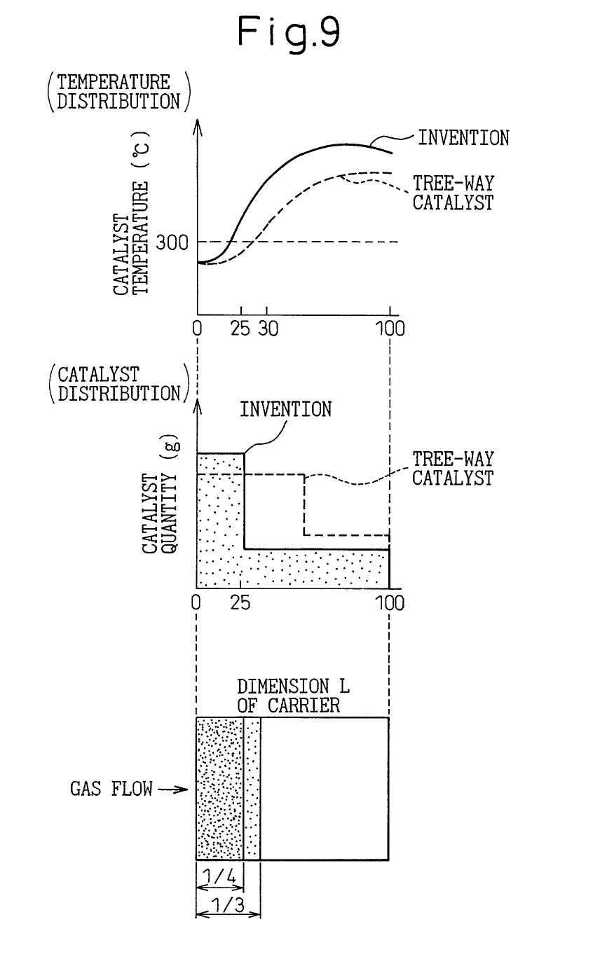

The third embodiment of the invention is shown in FIG. 9. In this embodiment, 50% or preferably 80% by weight or more of the entire catalyst is concentrated in a region from the upstream end of the carrier to a point one quarter to one third (25% to 33.3%) of the entire length of the ceramic carrier 2 (bottom of FIG. 9). Since the ceramic catalyst body 1 which directly supports the catalyst has a smaller heat capacity than the three-way catalyst of the prior art which is coated with γ-alumina, reaction starts earlier and the temperature rises faster as shown in the top graph of FIG. 9. The diagram in the middle of FIG. 9 shows an example of the ceramic carrier 2 where 50% of the entire catalyst is supported in a region from the upstream end of the carrier to a point one quarter of the entire length. Catalyst reaction begins in the upstream of the carrier while the heat generated in the upstream by the catalyst reaction is transmitted by the gas flow to the downstream, and therefore the exhaust gas can be purified sufficiently even when the quantity of catalyst is reduced in the downstream of the carrier.

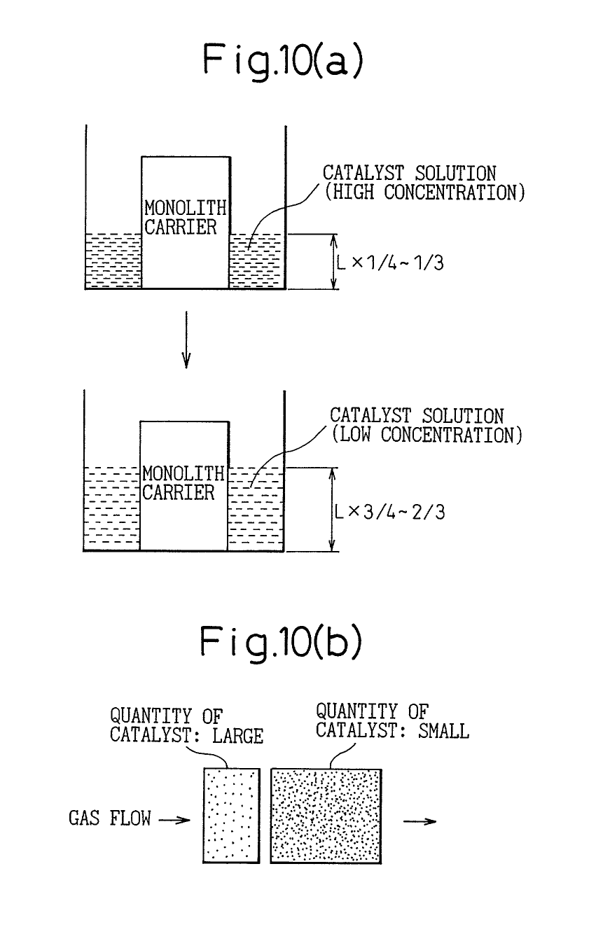

A method for manufacturing the ceramic catalyst body 1 having the constitution described above will be described below with reference to FIGS. 10(a) and 10(b). First, a portion of the carrier a quarter to third of the entire length is immersed in a high concentration solution of the catalyst, thereby to deposit 50% or preferably 80% by weight or more of the entire catalyst therein, as shown in FIG. 10(a). The processes of preparing the catalyst solution and drying after immersion are carried out similarly to those in the first embodiment. Then, the carrier is turned over and a portion of the carrier three quarters to two thirds of the entire length is immersed in a low concentration solution of the catalyst, thereby to deposit the rest of the entire catalyst therein. Alternatively, the carrier may be divided into a plurality of parts each supporting a different quantity of catalyst, which are arranged so that a part of a shorter length supporting a larger quantity of catalyst is disposed in the upstream, as shown in FIG. 10(b). Since less pressure loss occurs in the ceramic catalyst of the invention, the plurality of catalyst portions may be disposed in series.

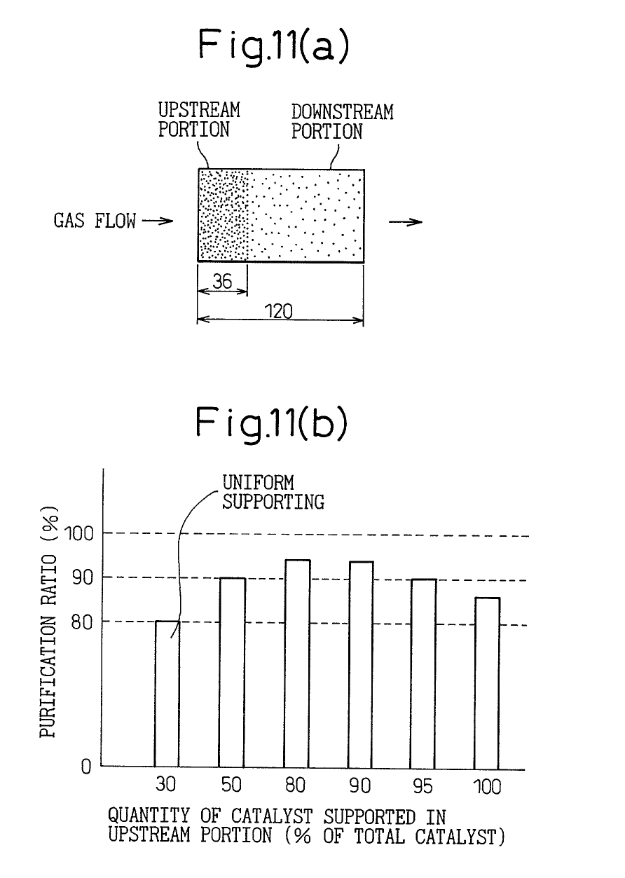

FIG. 11(b) is a graph comparing the purification performance among specimens of the ceramic carrier (φ83×L120) shown in FIG. 11(a) which support 30, 50, 80, 90 and 100% of the total quantity of catalyst, respectively, in the upstream portion (L36, 30% of the total length) and the rest of the catalyst in the downstream. The purification ratio was measured under conditions of engine displacement 2000 ml and gas flow rate of 4000 L/min. The portion of gas remaining not purified can be decreased to 10% or less when the 50% of the total quantity of the catalyst is supported in the upstream portion of the carrier, and the maximum effect can be achieved by setting the proportion to 80 or 90%. The proportion should be not higher than 95%, since the purification ratio decreases due to lower reaction in the downstream when the proportion exceeds 95%.

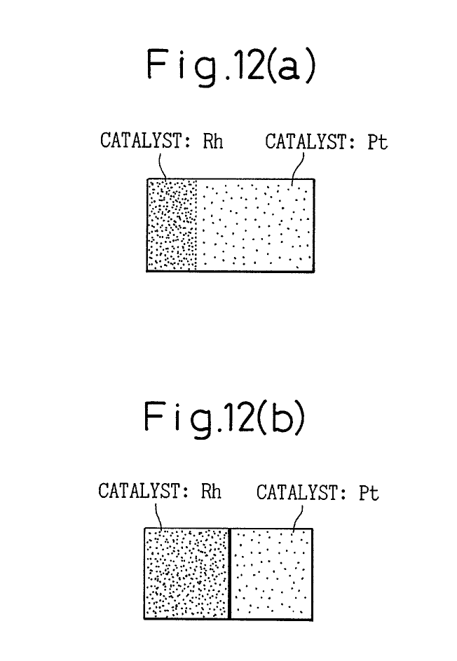

FIG. 12(a) shows the fourth embodiment of the invention. In the ceramic catalyst body 1 of this embodiment, a plurality of kinds of catalyst are supported on the ceramic carrier 2, with a catalyst having higher heat resistance supported in the upstream of the gas flow and a catalyst having lower heat resistance supported in the downstream. In a constitution in which the catalyst is supported directly on the ceramic carrier 2 without a γ-alumina coat in-between as in the present invention, the shorter distance between catalyst particles may lead to deterioration of the catalyst due to heat, such as a sintering phenomenon in which the catalyst particles bond with each other and cause the catalyst to evaporate. To avoid such a problem, when Pt, Pd, Rh or the like is used as the catalyst in this embodiment, for example, Rh which has higher heat resistance is supported in the upstream portion and Pt (or Pd) is supported in the downstream portion in consideration of the melting point and sintering temperature of the catalyst elements shown in Table 1,instead of supporting the catalyst elements uniformly over the ceramic carrier 2. The process of depositing the different catalyst elements separately in the upstream and downstream portions can be carried out similarly to the fourth embodiment. Serial arrangement as shown in FIG. 12(b) may also be employed where the carrier is divided into parts each supporting the catalyst.

TABLE 1

| Catalyst element | Melting point | Sintering temperature |
|---|---|---|
| Pd | 1552° C. | 500-750° C. |
| Pt | 1772° C. | 570-880° C. |
| Rh | 1966° C. | 600-1000° C. |

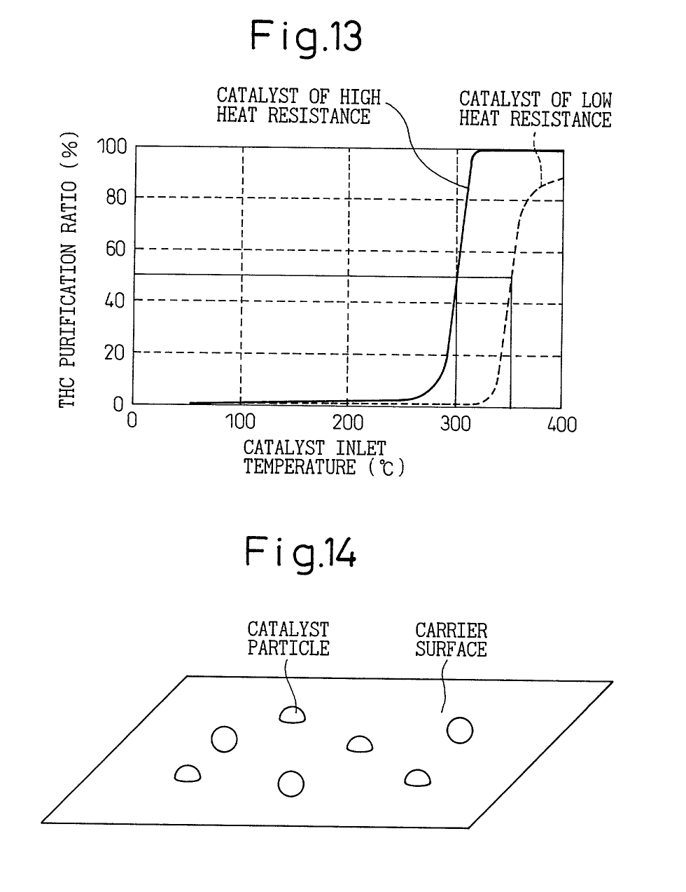

The method for evaluating and determining the heat resistance of the catalyst will now be described below. First, a catalyst to be evaluated is deposited on the ceramic carrier 2 of the invention, and is subjected to aging at 1000°C. for 24 hours. Then, the purification performance of the catalyst is measured by the same method as that described above. With reference to FIG. 13 showing the relationship between catalyst inlet temperature and the purification ratio, a catalyst which shows an inlet temperature for 50% purification ratio (T50) of 30020 C. or lower is regarded as having high heat resistance and one showing an inlet temperature of 350°C. or lower is regarded as having low heat resistance.

To improve the catalytic performance of the ceramic catalyst body, the catalyst particles may be formed in a shape that has larger surface area than a sphere or semi-sphere of the same mass. Provided that the catalyst particles each have the same weight, the surface area is minimum when the catalyst particle has a spherical (semi-spherical) shape as shown in FIG. 14. Thus, the surface area is increased for higher catalytic performance by making the catalyst particles in a shape other than spherical (or semi-spherical) shape.

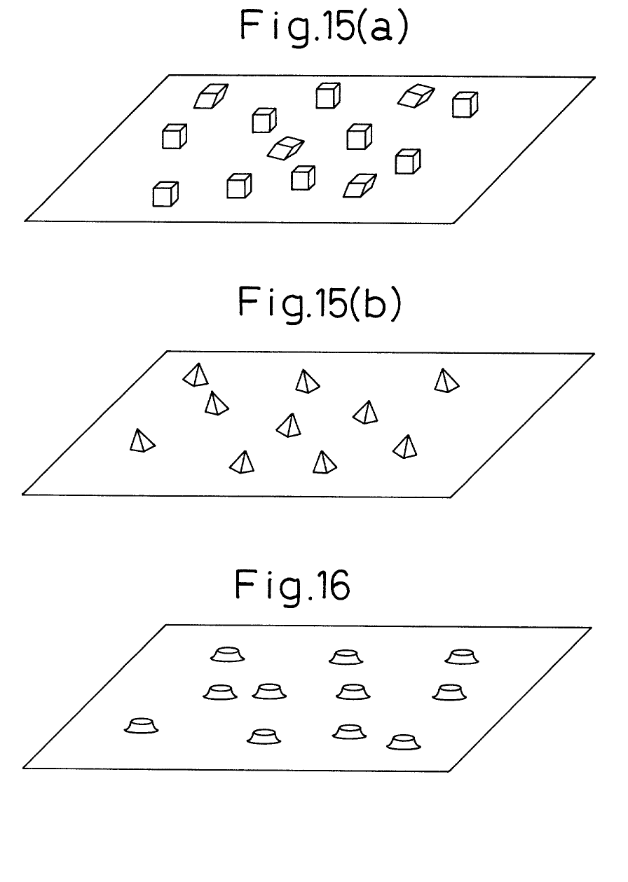

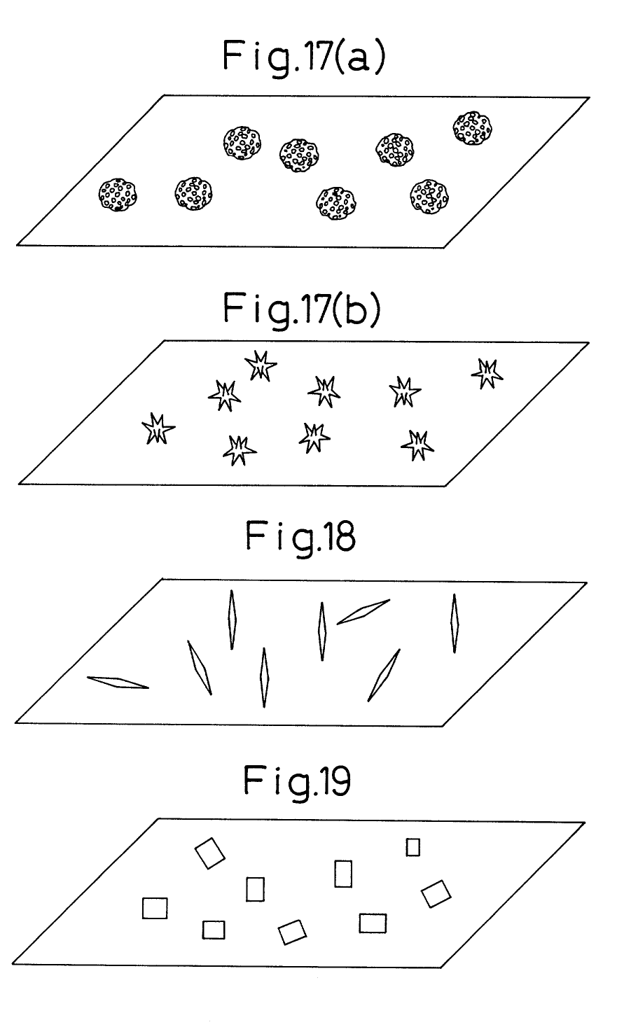

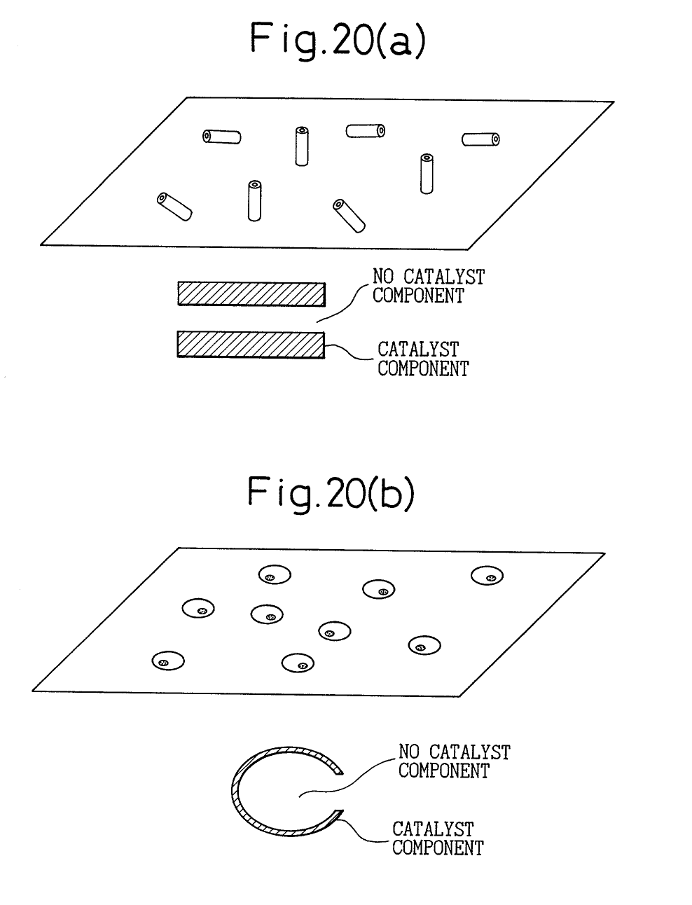

Specifically, the shape of the catalyst particles may be at least one of a polyhedron, conical shape or cone missing a part thereof, a substantially spherical shape having surface irregularities or projections, needles, flakes and hollow particles. FIGS. 15 to 20 show examples of such shapes. FIGS. 15(a) and 15(b) show particles of polyhedron shape, particularly hexahedrons and tetrahedrons. FIG. 16 shows a truncated conical shape. FIGS. 17(a) and 17(b) show particles which have surface irregularities or projections provided on a spherical or semi-spherical surface. The needle shape shown in FIG. 18 or the flake shape as shown in FIG. 19 may also be used. FIGS. 20(a) and 20(b) show hollow catalyst particles, FIG. 20(a) show particles of tube shape and FIG. 20(b) show particles which have a bottomed hole, both providing a large surface area due to the inner surface of the hollow space.

The exhaust gas purification performance depends on the surface area of the catalyst, and the larger the surface area, the higher the probability of making contact with the exhaust gas, resulting in higher performance. Therefore, the catalytic performance can be improved by using catalyst particles of a shape other than spherical, without increasing the quantity of catalyst supported.

Shape of the catalyst particles can be controlled by changing the conditions of the process of depositing the catalyst component, or by applying a post-process after depositing the catalyst. Conditions of the process of depositing the catalyst component involve the precursor of the catalyst component, the solvent in which the catalyst component is dissolved and the sintering atmosphere, which may be changed to obtain particles of a particular shape. Alternatively, a post-process such as pickling or dry etching may be applied after depositing the catalyst and sintering.

The spherical particles shown in FIG. 14 are obtained by immersing the ceramic carrier in an ethanol solution containing 0.07 mol/L of ammonium chloroplatinate and 0.05 mol/L of rhodium chloride and, after drying, sintering the catalyst at 8000° C. for two hours in an air atmosphere. To obtain the particles of hexahedron shape shown in FIG. 15(a), the precursor of the catalyst and the solvent are changed to use 3N solution of HCl containing 0.07 mol/L of ammonium tetracloroplatinate and 0.01 mol/L of rhodium acetate dimer. The particles having hexahedron shape are obtained by immersing the ceramic carrier in this solution and, after drying, sintering the catalyst at 800° C. for two hours in air atmosphere.

The particles having irregular surface shown in FIG. 17(a) are obtained by immersing the ceramic carrier in an ethanol solution containing 0.07 mol/L of ammonium chloroplatinate and 0.05 mol/L of rhodium chloride similarly to the spherical particles and, after drying, sintering the catalyst at 800° C. for two hours in air atmosphere, then applying a post-process, of immersion in aqua regia (20° C.) for 10 minutes, which results in particles having irregular surface.

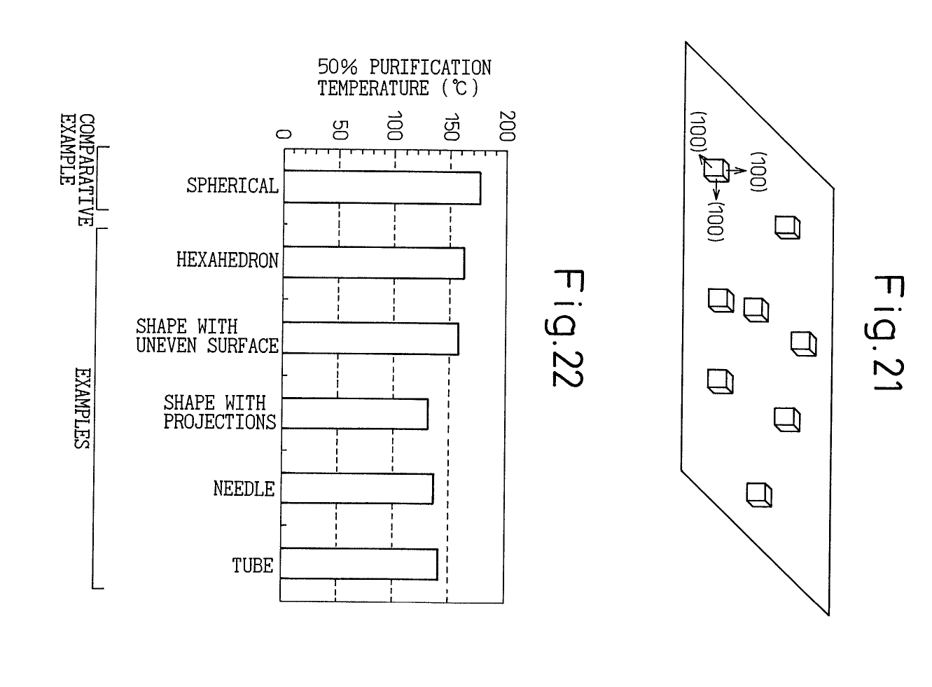

To improve the catalytic performance of the ceramic catalyst, it is also beneficial to orient the crystal plane of the catalyst in a plane of maximum catalytic activity. Even when the catalyst particles have the same shape and the same surface area, the catalyst reaction is accelerated and the purification performance is improved when the crystal plane of the catalyst is oriented in a plane of maximum catalytic activity. FIG. 21 shows a case where Pt is used as the catalyst component and the crystal plane of the catalyst is oriented in Pt (100) plane maximum activity for directly decomposing NO, with the catalyst particles having hexahedron shape. Catalytic activity can be improved for higher catalytic performance as described above.

The orientation of the catalyst particles can be controlled by adjusting the conditions of the process of depositing the catalyst component. The conditions include the precursor of the catalyst component, the solvent in which the catalyst component is dissolved and the sintering atmosphere, which may be changed to obtain particles oriented in a particular plane. The catalyst particles oriented in Pt (100) plane as shown in FIG. 21 can be obtained by immersing the ceramic carrier in an ethanol solution containing 0.07 mol/L of ammonium chloroplatinate and 0.05 mol/L of rhodium chloride and, after drying, sintering the catalyst at 800° C. for two hours in a hydrogen atmosphere.

FIG. 22 compares the purification performance of the catalysts of various particle shapes supported by a ceramic carrier having a multitude of pores formed in the surface thereof. Pt and Rh were used as the catalyst, and various particle shapes were obtained by adjusting the conditions of the process of depositing the catalyst component. The density of the catalyst supported was set to 1.5 g/L in all cases. The ceramic carrier was made by substituting 10% by weight of the Al source of the cordierite materials such as talc, kaolin and alumina with a W compound having different valence, mixing a binder and the like with this material, forming the mixture into a honeycomb, drying the preform at 90° C. for six hours and sintering at 1300° C. for 2.5 hours, thereby forming defects which become pores.

The 50% purification temperature of the ordinate in FIG. 22 can be used as an index for evaluating the purification performance, and was determined as follows. A model gas containing HC (hydrocarbon) was introduced into samples (measuring φ15×L10 mm) of the ceramic catalyst to be evaluated for the purification performance. While raising the sample temperature gradually, the temperature at which the HC purification ratio calculated by the following formula becomes 50% was determined and taken as the 50% purification temperature.

HC purification ratio=[Incoming HC concentration−Outgoing HC concentration]/[Incoming HC concentration]×100

As shown in FIG. 22, any of a hexahedron, a shape having surface irregularities, a shape having projections, a needle and a tube shape showed lower 50% purification temperature than the ceramic catalyst body of spherical particles, thus achieving improved purification performance. As described above, higher catalytic performance can be achieved even when the same quantity of catalyst is supported, by changing the particle shape to increase the surface area.

What is claimed is:

1. A ceramic catalyst body comprising a ceramic carrier capable of supporting a catalyst directly on the surface of a substrate ceramic and a catalyst component supported by the ceramic carrier, wherein the quantity of catalyst supported by a unit volume of the carrier at the middle portion thereof where the gas stream is maximum is set to 1.1 times that of the periphery or larger.

2. A ceramic catalyst body comprising a ceramic carrier capable of supporting a catalyst directly on the surface of a substrate ceramic, wherein the surface area per unit volume of carrier at the middle portion thereof where the gas stream velocity is highest is set to 1.1 times that of the periphery or larger.

3. The ceramic carrier according to claim 2, wherein the carrier is formed in a monolith, while the middle portion of the carrier is made to have a high cell density or in polygonal or circular cell form, and the peripheral portion of the carrier is made to have a low cell density or in rectangular, hexagonal or triangular cell form.

4. The ceramic catalyst body according to claim 1, wherein, with the projection area of a gas inlet onto the ceramic carrier denoted as S, the middle portion of the carrier is identified as a region which has a cross sectional area in a range from 1.1 to 2 times the projection area S.

5. A ceramic catalyst body comprising a ceramic carrier capable of supporting a catalyst directly on the surface of a substrate ceramic and a catalyst component supported by the ceramic carrier, wherein 50% by weight or more of the entire catalyst is concentrated in a region from the upstream end of the carrier to a point one quarter to one third of the entire length.

6. A ceramic catalyst body comprising a ceramic carrier capable of supporting a catalyst directly on the surface of a substrate ceramic and a catalyst component supported by the ceramic carrier, wherein a catalyst having high heat resistance is disposed in the upstream of the incoming gas and a catalyst having low heat resistance is disposed in the downstream.

7. The ceramic carrier according to claim 6, wherein the catalyst having higher heat resistance is a catalyst of inlet temperature not higher than 300° C. with a purification ratio of 50%, and the catalyst having lower heat resistance is a catalyst of inlet temperature not lower than 350° C. with a purification ratio of 50%.

8. The ceramic catalyst body according to claim 1, wherein the cross sectional area of the ceramic carrier is larger than the cross sectional area of a gas inlet tube connected to the ceramic carrier.

9. A ceramic catalyst body comprising a ceramic carrier capable of supporting a catalyst directly on the surface of a substrate ceramic and a catalyst component supported by the ceramic carrier, wherein the catalyst comprises particles of a shape that has a larger surface area than spherical or semi-spherical particles of the same weight.

10. The ceramic catalyst body according to claim 9, wherein the shape of the catalyst particles is at least one of polyhedron, conical shape or cone missing a part thereof, substantially spherical shape having surface irregularities or projections, needles and hollow particles.

11. A ceramic catalyst body comprising a ceramic carrier capable of supporting a catalyst directly on the surface of a substrate ceramic and a catalyst component supported by the ceramic carrier, wherein the catalyst is oriented in a plane which has high catalyst activity.

12. The ceramic catalyst body according to claim 9, wherein the catalyst is supported in the pores by impregnating the ceramic carrier with a catalyst solution and sintering.

13. The ceramic catalyst body according to claim 1, wherein one or more constituent elements of the ceramic substrate is substituted with an element other than the constituent element, and the ceramic carrier is capable of supporting the catalyst component directly on the substituting element.

14. The ceramic catalyst body according to claim 13, wherein the catalyst component is supported directly on the substituting element by chemical bond.

15. The ceramic catalyst body according to claim 13, wherein the substituting element is one or more elements having d or f orbit in the electron orbits thereof.

16. The ceramic catalyst body according to claim 1, wherein the ceramic catalyst has a multitude of pores which are capable of directly supporting the catalyst on the surface of the substrate ceramic so that the catalyst component can be supported directly in the pores.

17. The ceramic catalyst body according to claim 16, wherein the pores comprise at least one kind selected from among a group of defects in the ceramic crystal lattice, microscopic cracks in the ceramic surface and missing defect of the elements which constitute the ceramic.

18. The ceramic catalyst body according to claim 17, wherein the microscopic cracks are 100 nm or smaller in width.

19. The ceramic catalyst body according to claim 17, wherein the pores have diameter or width 1000 times the diameter of the catalyst ion to be supported or smaller, and the density of pores is 1×10¹¹/L or higher.

20. The ceramic catalyst body according to claim 17, wherein the substrate ceramic contains cordierite as the major component, and the pores are constituted from defects formed by substituting a part of the constituent elements of the cordierite with a metal element having a different value of valence.

21. The ceramic catalyst body according to claim 20, wherein the defects comprise at least one kind, oxygen defect or lattice defect, and the density of cordierite crystal which includes at least one defect in a unit crystal lattice of cordierite is set to 4×10⁻⁶% or higher.
